(19) United States
(12) Patent Application Publication
(10) Pub. No.: US 2015/0158764 A1
(43) Pub. Date: Jun. 11, 2015

(54) Method for Manufacturing Touch Screen Panel and Method for Manufacturing Tempered Glass Substrate

(71) Applicant: MELFAS INC., Seongnam-si, Gyeonggi-do (KR)

(72) Inventor: Sungil NAM, Seoul (KR)

(73) Assignee: MELFAS INC., Seongnam-si, Gyeonnggi-do (KR)

(21) Appl. No.: 14/414,069

(22) PCT Filed: Jul. 10, 2013
(86) PCT No.: PCT/KR2013/006155

§ 371 Date: Jan. 9, 2015

(30) Foreign Application Priority Data
Jul. 10, 2012 (KR) 10-2012-0075066

(51) Int. Cl. C03C 21/00; C03B 33/02; G06F 3/041; B24B 1/00

(52) U.S. Cl. CPC C03C 21/002; B24B 1/00; C03B 33/02; G06F 3/0412; G06F 2203/04103

(57) ABSTRACT

Disclosed are a method for manufacturing a touch screen panel and a method for manufacturing a tempered glass substrate. The method for manufacturing a touch screen panel comprises the steps of: smoothing the first surface of a raw glass substrate by polishing the surface of the raw glass substrate; forming a groove, for each cell unit, in the first surface of the raw glass substrate; tempering the raw glass substrate; forming a transparent electrode and a wiring pattern on the second surface of the raw glass substrate; and cutting the raw glass substrate for each cell unit along the groove, wherein the second surface is opposite the first surface.

### TECHNICAL FIELD

The present invention relates to methods for manufacturing a touch screen panel and a tempered glass substrate, and in particular, to methods for manufacturing a touch screen panel and a tempered glass substrate to have high sidewall strength, even when they are manufactured in the form of a sheet.

### BACKGROUND ART

A touch screen panel with glass substrate may be generally classified into a cell type and a sheet type. In a method of manufacturing the cell-type touch screen panel, a raw glass substrate is cut to fit its size on that of a display device, and then, a tempering step and a cell processing step are performed. In a method of manufacturing the sheet-type touch screen panel, a cell processing step is performed on a raw glass substrate, on which a tempering step has been performed, and then, a cutting step is performed to fit a size of the touch screen panel on that of a display device.

For the cell-type touch screen panel, since the cutting step and the tempering step are sequentially performed on the raw glass substrate, it is possible to realize high strength and print a cover glass in different colors, but it is difficult to mass-produce the cell-type touch screen panel, compared with the sheet type. Also, since the tempering step and a step of form transparent electrodes and wiring patterns are performed for each cell unit, its manufacturing cost is relatively high.

When compared with the cell-type touch screen panel, the sheet-type touch screen panel is advantageous in terms of mass-production and manufacturing cost, because a transparent electrode and a wiring pattern are formed on each cell of a raw glass substrate and then the cutting step is performed. However, for the sheet-type touch screen panel, the tempering and cutting steps are sequentially performed on a raw glass substrate and a sidewall portion exposed by the cutting step is an ordinary (i.e., not-tempered) glass. Thus, when compared with the cell-type touch screen panel, the sheet-type touch screen panel has weak sidewall strength and a difficulty in achieving a curved profile of a glass.

### DISCLOSURE

### Technical Problem

An embodiment of the present invention provides a sheet-type touch screen panel with high sidewall strength and a method for manufacturing the same.

Another embodiment of the present invention provides a sheet-type tempered glass substrate with high sidewall strength and a method for manufacturing the same.

The present invention is not limited to only the above subject matters, and other subject matters not described here will be clearly understood by one of ordinary skill in the art on he basis of the following description of the present invention.

### Technical Solution

According to example embodiments of the present invention, a method for manufacturing a touch screen panel may include smoothing a first surface of a raw glass substrate using a polishing process, forming a groove, for each cell unit, in the first surface of the rater glass substrate, tempering the raw glass substrate; forming a transparent electrode and a wiring pattern on a second surface of the rater glass substrate, and cutting the raw glass substrate along the groove and for each cell unit. Here, the second surface is a surface positioned opposite to the first surface.

According to example embodiments of the present invention, a touch screen panel may be manufactured using the above method.

According to example embodiments of the present invention, a method for manufacturing a tempered glass substrate may include smoothing a surface of a raw glass substrate using a polishing process, forming a groove for each cell unit in the surface of the raw glass substrate, tempering the raw glass substrate, and cutting the raw glass substrate along the groove and for each cell unit.

Other embodiments of the present will be described with reference to the accompanying drawings and the following detailed description.

### Advantageous Effects

According to example embodiments of the present invention, it s possible to achieve the following effects.

A sheet-type touch screen panel with high sidewall strength and a method for manufacturing the same can be provided.

Further, a sheet-type tempered glass substrate with high sidewall strength and a method for manufacturing the same can be provided.

Technical effects of the present invention may not be limited to those described above, and as described in the present specification, the present invention can provide other various technical effects.

### DESCRIPTION OF DRAWINGS

FIG. 1 is a flow chart illustrating a method for manufacturing a touch screen panel according to an embodiment of the present invention.

FIGS. 2 through 7 are perspective and sectional views illustrating a manufacturing process, to which a method for manufacturing a touch screen panel according to an embodiment of the present invention is applied.

FIG. 8 is a sectional view of a touch screen panel according to an embodiment of he present invention.

FIG. 9 is a flow chart illustrating a method for manufacturing a tempered glass substrate according to an embodiment of the present invention.

FIG. 10 is a sectional view illustrating a tempered glass substrate according to an embodiment of the present invention.

### BEST MODE

Example embodiments of the present invention will now be described more fully with reference to the accompanying drawings, in which example embodiments are shown. Example embodiments of the present invention may, however, be embodied in many different forms and should not be construed as being limited to the embodiments set forth herein; rather, these embodiments are provided so that this disclosure will be thorough and complete, and will fully convey the concept of example embodiments to those of ordinary skill in the art.

It will be understood that when an element or layer is referred to as being “on” another element or layer, it can be directly on the other element or layer or intervening elements or layers may be present. Like numerals refer to like elements throughout.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from teachings of example embodiments.

Hereinafter, example embodiments of the present invention will be described with reference to the accompanying drawings.

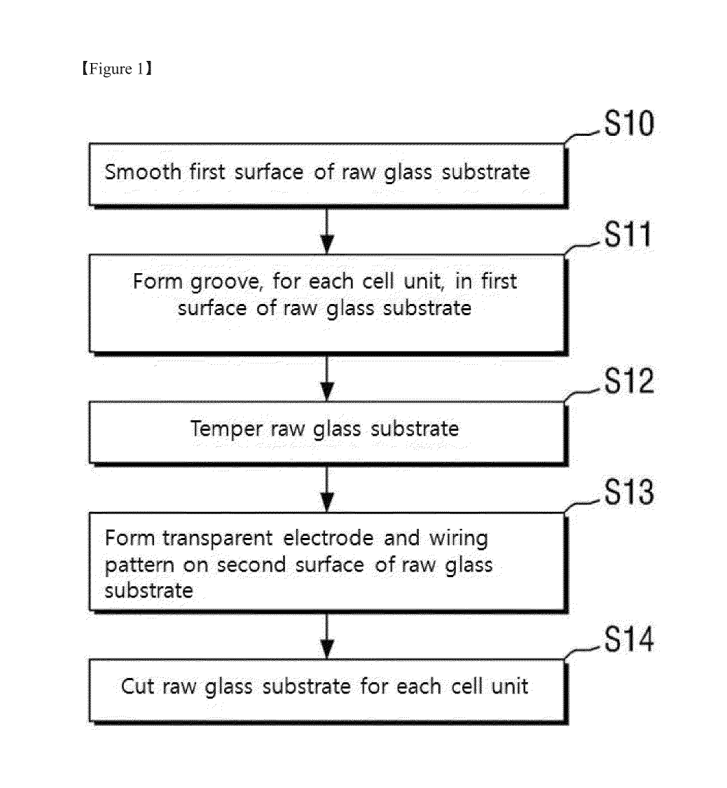

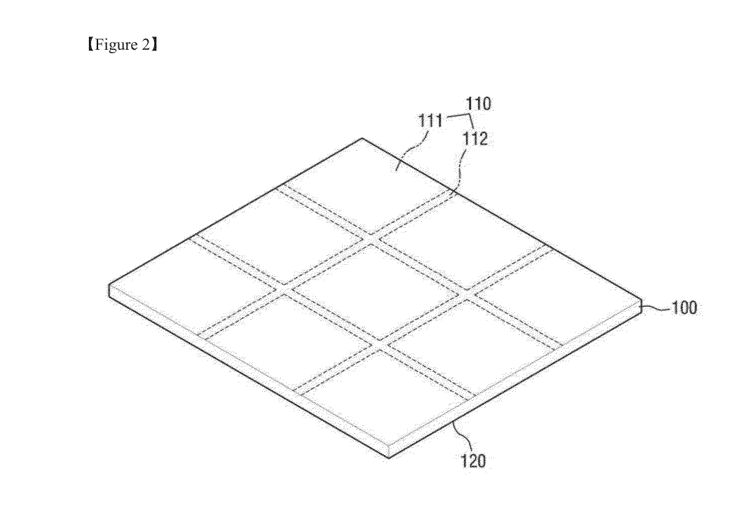

FIG. 1 is a flow chart illustrating a method for manufacturing a touch screen panel according to an embodiment of the present invention. FIGS. 2 through 7 are perspective and sectional views illustrating a manufacturing process, to which a method for manufacturing a touch screen panel according to an embodiment of the present invention is applied. The perspective and sectional views illustrated in FIGS. 2 through 7 will be referred to provide a detail description of the method for manufacturing a touch screen panel.

Firstly, a process may be performed to smooth a first surface 110 of a raw glass substrate 100 (in S10). The raw glass substrate 100 will be described with reference to FIG. 2, before a detail description of step S10.

The raw glass substrate 100 may be used as a base substrate of a touch screen panel 1000 and may be formed of or include a transparent glass substrate. The raw glass substrate 100 may be formed to have a rectangular parallelepiped shape, as shown in FIG. 2, but the present invention may not be limited thereto. For example, the raw glass substrate 100 may be shaped like a cube, polygonal pillar, or circular pillar.

The raw glass substrate 100 may include the first surface 110 and a second surface 120 opposite to the first surface 110. As an example of the opposite disposition of the first and second surfaces 110 and 120, the first surface 110 may be a top surface of the raw glass substrate 100 and the second surface 120 may be a bottom surface of the raw glass substrate 100. Referring to FIG. 2, the first surface 110 of the raw glass substrate 100 may refer to one of the largest two surfaces of the raw glass substrate 100 shaped like a rectangular parallelepiped, and the second surface 120 of the raw glass substrate 100 may refer to the other of the largest two surfaces of the raw glass substrate 100 shaped like a rectangular parallelepiped. However, the present invention may not be limited thereto, and the first and second surfaces 110 and 120 may be defined through various combinations of two surfaces of the raw glass substrate 100.

The first surface 110 of the raw glass substrate 100 may include a peripheral region 112 enclosing a unit cell region 111 and the unit cell region 111. The cell region 111 may refer to a region of the raw glass substrate 100 corresponding to one touch screen panel 1000, and the unit cell region 111 may be associated with the touch screen panel 1000 in a one-to-one manner. The peripheral region 112 may refer to a dummy region for dividing the raw glass substrate 100 into a plurality of the unit cell regions 111. For example, when all steps of a manufacturing process including a tempering process and a process for forming a transparent electrode and a wiring pattern are completed, the raw glass substrate 100 may be cut along the dummy region to form the unit cell regions 111 separated from each other.

The unit cell region 111 may have a shape corresponding to that of the touch screen panel 1000 and/or that of a display device, in which the touch screen panel 1000 is used. Although, for convenience in description, the unit cell region 111 having a rectangular shape is illustrated in FIG. 2, a shape of the unit cell region 111 may be variously changed (for example, to have a polygonal or circular shape). The peripheral region 112 may provide a process margin for cutting the raw glass substrate 100 and may be formed to have a shape enclosing the unit cell region 111. In the case where the unit cell region 111 is shaped like a rectangle as shown in FIG. 2, the peripheral region 112 may be provided to have a grid or lattice shape. However, if the unit cell region 111 has a different shape from the rectangle, the shape of the peripheral region 112 may be variously changed depending on the shape of the unit cell region 111 but under the requirement that it is formed to enclose the unit cell region 111.

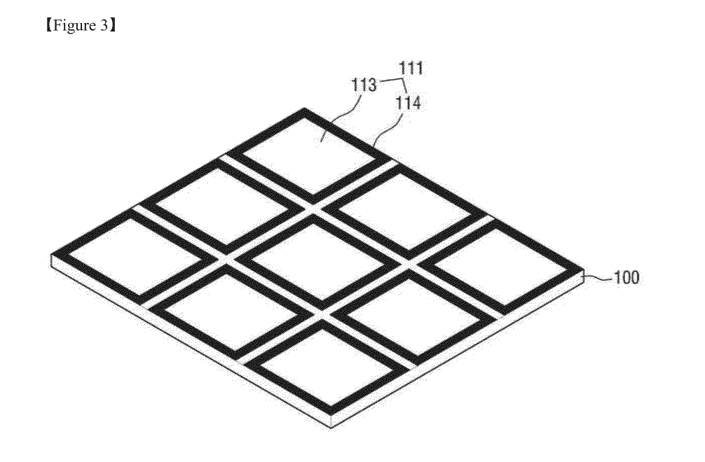

Referring to FIG. 3, the unit cell region 111 may include a touch sensing region 113 and an outer region 114. The touch sensing region 113 may be a portion of the unit cell region 111. on which column electrodes, patch electrodes, wiring patterns, and so forth are provided, and which is used to detect input information generated by a user's screen touch event or gesture. The outer region 114 may be provided around the touch sensing region 113 (for example, to enclose the touch sensing region 113), and moreover, wiring patterns and so forth may he disposed in the outer region 114 to transmit a sensing signal generated in the touch sensing region 113. Although, for convenience sake, the touch sensing region 113 and the outer region 114 described to be two different parts of the unit cell region 111, the touch sensing region 113 and the outer region 114 may be provided in the form of a single body, and moreover, the outer region 114 may also be configured to detect the input information generated by a user. In addition, although, for convenience in description, FIG. 3 illustrates an example in which the outer region 114 is provided to completely enclose the touch sensing region 113, a shape of the outer region 114 may be variously changed. For example, the outer region 114 may be locally provided at one or two sides of the touch sensing region 113.

Referring back to FIG. 1, a polishing step may be performed on a surface of the raw glass substrate 100 to smooth the first surface 110 of the raw glass substrate 100 (in S10). The smoothing step of polishing the raw glass substrate 100 may be performed on a surface (e.g., the first surface 110) of the raw glass substrate 100, and this makes it possible to improve flatness of the raw glass substrate 100 and allow sodium ions contained in the raw glass substrate 100 to be easily exchanged with potassium ions contained in potassium-containing source solution, when a tempering process will be performed on the raw glass substrate 100. The smoothing step of polishing the raw glass substrate 100 may be performed through various methods using various polishing agents.

In some example embodiments, before the smoothing of the first surface 110 of the raw glass substrate 100, a printed layer may be formed on the outer region 114 of the first surface 110 of the raw glass substrate 100. Referring to FIG. 3, as described above, the unit cell region 111 may include the touch sensing region 113 and the outer region 114, and the outer region 114 may be a region, which is located around the touch sensing region 113, and in which wiring patterns and so forth for transmitting a sensing signal generated in the touch sensing region 113 are provided. As an example, the outer region 114 may correspond to a non-display region of a display device, in which the touch se en panel 1000 is provided; that is, the outer region 114 may not be used to display images on the display device. In this case, the outer region 114 may not need to be transparent, and an opaque layer may be provided to veil wiring patterns disposed on the outer region 114. Accordingly, a printed layer may be formed on the outer region 114, before the smoothing step of polishing the first surface 110 of the raw glass substrate 100.

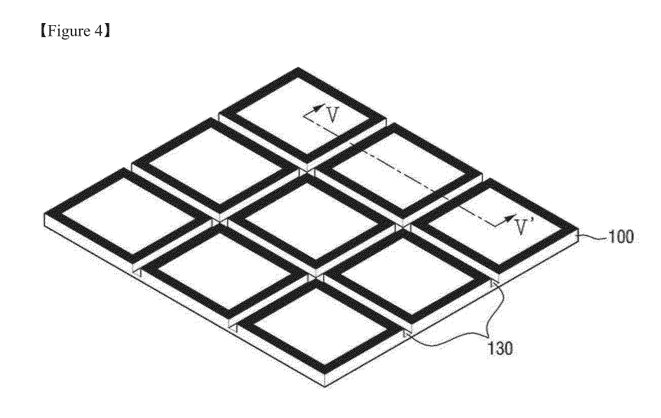

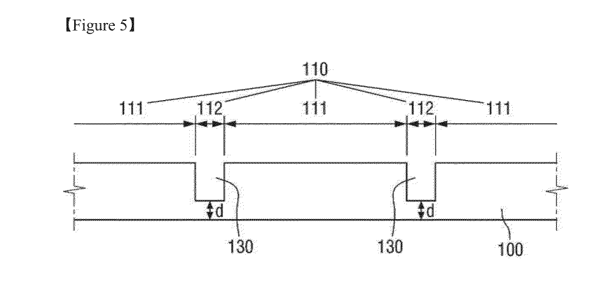

Thereafter, referring back to FIG. 1, a groove 130 may be formed, for each cell unit, in the first surface 110 of the raw glass substrate 100 (in S11). The process of forming the groove 130 will be described in more detail with reference to FIGS. 4 and 5.

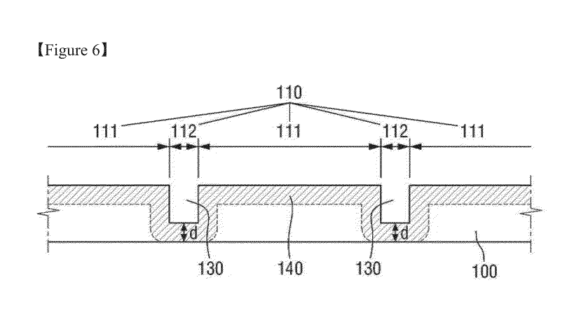

To form the groove 130 for each cell unit in the first surface 110 of the raw glass substrate 100, the groove 130 may be formed on the peripheral region 112 of the raw glass substrate 100. As described above, the peripheral region 112 may be used as a dummy region for dividing the raw glass substrate 100 into a plurality of the unit cell regions 111, and when all steps of a manufacturing process including a tempering process and a process for forming a transparent electrode and a wiring pattern are completed, the raw glass substrate 100 may be cut along the peripheral region 112 to form the touch screen panels 1000 separated from each other or in each cell unit. Accordingly, a vertically-cut section of the raw glass substrate 100 or a side surface of the touch screen panel 1000 may be formed along a boundary portion between the raw glass substrate 100 and the peripheral region 112. In the method for manufacturing the touch screen panel 1000 according to an embodiment of the present invention, the groove 130 may be formed on the peripheral region 112 of the raw glass substrate 100 to perform a tempering process on the cut section of the raw glass substrate 100 for the touch screen panel 1000 or the side surface of the touch screen panel 1000. The tempering process will be described in more detail with reference to FIG. 6.

Referring to FIGS. 4 and 5, the groove 130 may be formed to have a rectangular or tetragonal shape. However, FIGS. 4 and 5 are provided to illustrate an example of the shape of the groove 130 for convenience' sake, and the groove 130 may be formed to have one of various shapes, such as polygonal or circular shapes.

When the groove 130 is formed for each cell unit in the first surface 110 of the raw glass substrate 100, the groove 130 may be formed by adjusting a thickness d of the peripheral region 112 of the raw glass substrate 100. In the case where the groove 130 is formed on the peripheral region 112 of the raw glass substrate 100, the thickness d of the peripheral region 112 of the raw glass substrate 100 may become smaller than a thickness of the unit cell region 111 of the raw glass substrate 100, and thus, it is possible to perform a subsequent tempering process on a staircase portion between the unit cell and peripheral regions 111 and 112 and thereby to improve a sidewall strength of the touch screen panel 1000. Relationship between the thickness d of the peripheral region 112 of the raw glass substrate 100 and the tempering process will be described in more detail with reference to FIG. 6.

After forming the groove 130 for each cell unit in the first surface 110 of the raw glass substrate 100 and before performing the tempering process on the raw glass substrate 100, cleansing and drying steps may be performed on the raw glass substrate 100 provided with the groove 130 to remove impurities or by-products produced in the step of forming the groove 130, as shown in FIG. 5.

Next, referring back to FIG. 1, the raw glass substrate 100 may be tempered (in S12). The process of tempering the raw glass substrate 100 will be described in more detail with reference to FIGS. 5 and 6.

The process of tempering the raw glass substrate 100 may be performed using a chemical tempering treatment. In such a chemical tempering treatment, potassium-containing source solution at a predetermined temperature may be provided on the raw glass substrate 100 for a predetermined time. For example, the chemical tempering treatment may include dipping the raw glass substrate 100 into the potassium-containing source solution at a temperature of 300° C.-400° C. for 4 to 6 hours. Here, the potassium-containing source solution may refer to one of chemical solutions containing potassium ions (e.g., potassium nitrate, potassium hydrogenphosphate, potassium chloride, and potassium phosphate).

If the raw glass substrate 100 is dipped into the potassium-containing source solution, sodium ions of the surface of the raw glass substrate 100 and potassium ions of the potassium-containing source solution may be substituted with each other. For example, sodium ions may be departed from the surface of the raw glass substrate 100, and then, positions of the departed sodium ions may be occupied by potassium ions. As a result of the ion substitution, the surface of the raw glass substrate 100 may have an increased density and consequently a compressed structure. That is, the surface of the raw glass substrate 100 may be strengthened.

The dipping of the raw glass substrate 100 into the potassium-containing source solution may be performed in such a way that the first surface 110 of the raw glass substrate 100 is dipped into potassium-containing source solution. That is, in the touch screen panel 1000, the first surface 110 of the raw glass substrate 100 may be used to receive a user's touch signal, and thus, the tempering process may be needed to be performed on the first surface 110 of the raw glass substrate 100. Accordingly, in order to strengthen the first surface 110 of the raw glass substrate 100, the first surface 110 of the raw glass substrate 100 may be dipped into the potassium-containing source solution.

FIG. 6 illustrates a section of the raw glass substrate 100, to which the tempering process has been applied. Since the first surface 110 of the raw glass substrate 100 is tempered, a surface portion of the first surface 110 of the raw glass substrate 100 may be strengthened to form a tempered region 140. For example, the tempered region 140 may be formed near the staircase portion of the raw glass substrate 100 or near the groove 130. In some example embodiments, to maximize the formation of the tempered region 140, the groove 130 may be formed in such a way that the peripheral region 112 of the raw glass substrate 100 has a thickness ranging from 10 μm to 100 μn.

Referring to FIG. 6, the tempered region 140 may be conformally formed along an exposed surface of the first surface 110 of the raw glass substrate 100. Thus, the tempered region 140 may be formed to have a shape variously changed depending on a shape of the groove 130 formed in the raw glass substrate 100.

In a method for manufacturing a touch screen panel according to an embodiment of the present invention, the groove 130 may be formed on the peripheral region 112 of the raw glass substrate 100, and then, the tempering process may be performed to strengthen a surface of the raw glass substrate 100. Thus, it is possible to temper the sidewall portion of the unit cell region 111, and moreover, even when the raw glass substrate 100 is cut to form a plurality of the touch screen panels 1000 separated from each other in each cell unit, it is possible to manufacture the sheet-type touch screen panel 1000, in which the touch screen panel 1000 with a tempered sidewall is provided.

In some example embodiments, a process of pre-heating the raw glass substrate 100 may be performed before dipping the raw glass substrate 100 into the potassium-containing source solution. The process of pre-heating the raw glass substrate 100 may include pre-heating the raw glass substrate 100 to a temperature of 350-400° C. for 30-90 minutes. By pre-heating the raw glass substrate 100 before dipping the raw glass substrate 100 into the potassium-containing source solution, it is possible to more easily induce an ion substitution reaction in a subsequent tempering process.

A chemical tempering treatment has been described as an example of a process of tempering the raw glass substrate 100, but the raw glass substrate 100 may be tempered using other chemical tempering processes or various physical tempering processes.

Next, a cleaning step may be performed on the tempered raw glass substrate 100 to remove impurities or by-products, which may remain on the rater glass substrate 100 or, in particular, on the groove 130 of the raw glass substrate 100.

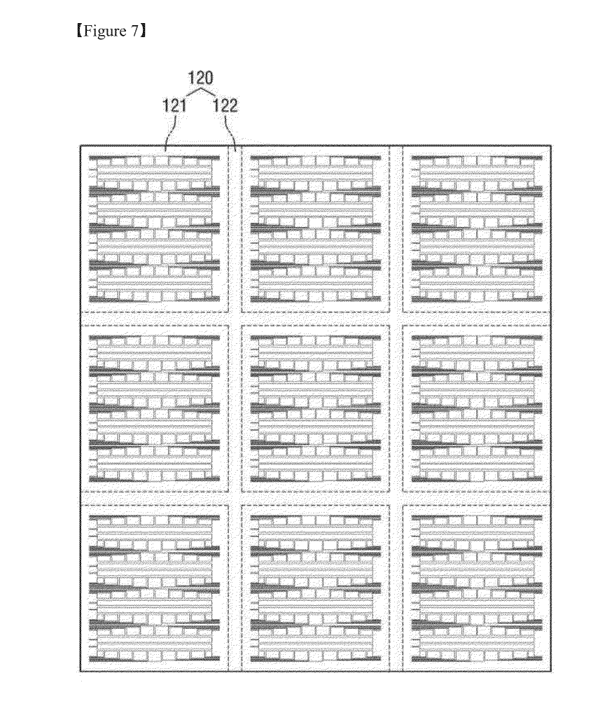

Thereafter, referring back to FIG. 1, a transparent electrode and a wiring pattern 150 may be formed on the second surface 120 of the raw glass substrate 100 (in S13). The process of forming the transparent electrode and the wiring pattern 150 will be described in more detail with reference to FIG. 7.

The second surface 120 of the raw glass substrate 100 may be a surface positioned opposite to the first surface 110 and may include a unit cell region 121 and a peripheral region 122. The unit cell and peripheral regions 121 and 122 of the second surface 120 may correspond to the unit cell and peripheral regions 121 and 122 of the first surface 110. Various transparent electrodes and wiring patterns 150, which may be needed to operate the touch screen panel 1000, may be formed on the unit cell region 121 of the second surface 120 of the raw glass substrate 100. As examples of the various transparent electrodes, a column-shaped sensing electrode and a patch-shaped driving electrode may be formed, and, as examples of the wiring patterns 150, wires for providing driving signals to the driving electrode and providing sensing signals to the sensing electrode may be formed. In some example embodiments, the formation of the transparent electrodes and the wiring patterns 150 may include performing a low-temperature deposition process. FIG. 7 illustrates the transparent electrode and the wiring pattern 150 that are provided in the form of a single layer formed on the second surface 120 of the raw glass substrate 100, and this configuration is disclosed in Korean Patent Application No. 10-2011-0121807 entitled “Touch sensing device and method of manufacturing the same”, filed on Nov. 21, 2011, the contents of which are hereby incorporated by reference.

The process of forming the transparent electrode and the wiring pattern 150 on the second surface 120 of the raw glass substrate 100 may be performed after the tempering process of the raw glass substrate 100. In the tempering process of the raw glass substrate 100, the raw glass substrate 100 may be heated to a temperature of about 350-400° C. In this case, if the transparent electrode and the wiring pattern 150 are formed on the second surface 120, before the tempering process of the raw glass substrate 100, the transparent electrode and the wiring pattern 150 may be separated from the raw glass substrate 100, because of the increased temperature of the raw glass substrate 100. Accordingly, after the process of tempering the raw glass substrate 100, the transparent electrode and the wiring pattern 150 may be formed on the second surface 120 of the raw glass substrate 100.

Thereafter, referring back to FIG. 1, the raw glass substrate 100 may be cut along the groove 130 or for each cell unit (in S14). The process of cutting the raw glass substrate 100 for each cell unit may include cutting the peripheral region 112 along the groove 130 of the raze glass substrate 100, chamfering the cut edge portion, and then, performing cleaning and drying steps. The cutting of the tempered raw glass substrate may be performed using various methods (e.g., scribing, etching, water jet cutting, and laser cutting methods).

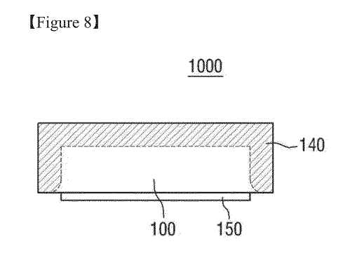

FIG. 8 is a sectional view of a touch screen panel according to an embodiment of the present invention. The touch screen panel 1000 may include the raw glass substrate 100, in which the tempered region 140 is formed, and the transparent electrode and the wiring pattern 150, which are formed on a surface of the raw glass substrate 100. The touch screen panel 1000 according to an embodiment of the present invention may be manufactured using the afore-described method for manufacturing a touch screen according to an embodiment of the present invention, and thus, a detail description thereof pray be omitted below.

As shown in FIG. 8, the tempered region 140 may be formed in the sidewall portion of the touch screen panel 1000. That is, in a method for manufacturing the touch screen panel 1000 according to the present invention, the groove 130 may be formed along a boundary portion of the unit cell region 111 of the raw glass substrate 100 (e.g., in the peripheral region 112), and then, the tempering process may be performed on the resulting structure with the groove 130, and thus, it is possible to form the tempered region 140 in the sidewall portion of the touch screen panel 1000 and to manufacture the touch screen panel 1000 with an improved strength property, even when the touch screen panel 1000 is of the sheet type.

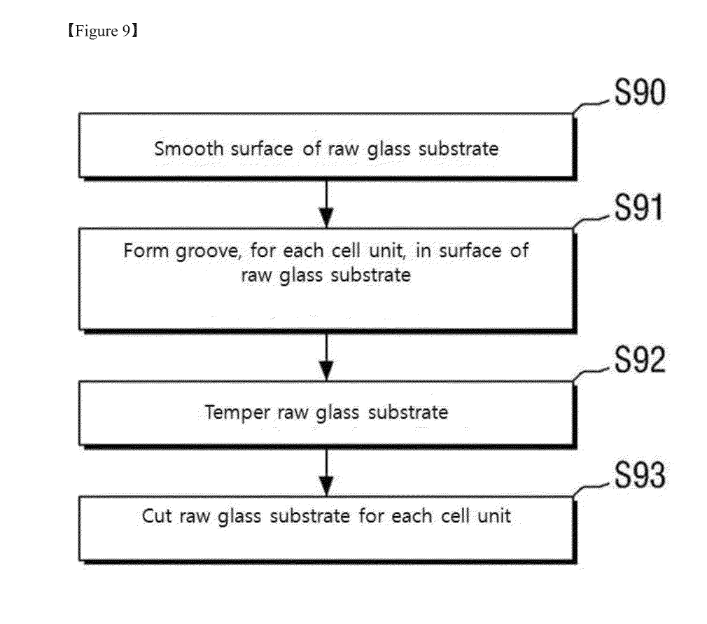

FIG. 9 is a flow chart illustrating a method for manufacturing a tempered glass substrate according to an embodiment of the present invention.

Firstly, a polishing process may be performed on a surface of a raw glass substrate 100, and thus, the surface of the raw glass substrate 100 may have a smooth profile (in S90). The process of polishing or smoothing the surface of the raw glass substrate 100 may be performed using substantially the same method as that of smoothing the first surface of the raw glass substrate described with reference to FIG. 1, and thus, a detail description thereof may be omitted below.

Thereafter, a groove may be formed, for each cell unit, in a surface of the raw glass substrate 100 (in S91). The process of forming a groove on a surface of the raw glass substrate 100 may be performed using substantially the same method as that of forming the groove on the first surface of the raw glass substrate described with reference to FIG. 1, and thus, a detail description thereof may be omitted below.

Thereafter, the raw glass substrate 100 may be tempered (in S92). The process of tempering the raw glass substrate 100 may be performed using substantially the same method as that of tempering the raw glass substrate described with reference to FIG. 1, and thus, a detail description thereof may be omitted below.

Next, the raw glass substrate 100 may be cut along the groove or for each cell unit (in S93). The process of cutting the raw glass substrate 100 may be performed using substantially the same method as that of cutting the raw glass substrate described with reference to FIG. 1, and thus, a detail description thereof may be omitted below.

In other words, when compared with the afore-described method for manufacturing a touch screen panel according to an embodiment of the present invention, a method for manufacturing a tempered glass substrate according to an embodiment of the present invention may have a difference in that the process of forming the transparent electrode and the wiring pattern is omitted, and other processes may be substantially the same.

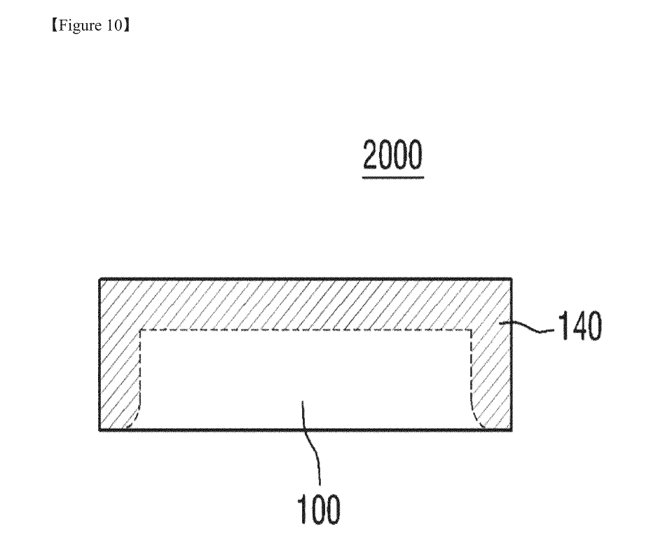

FIG. 10 is a sectional view illustrating a tempered glass substrate according to an embodiment of the present invention. A tempered glass substrate 2000 may include the raw glass substrate 100, in which the tempered region 140 is formed. The tempered glass substrate 2000 according to an embodiment of the present invention may be manufactured using the afore-described method for manufacturing a touch screen according to an embodiment of the present invention, and thus a detail description thereof may be omitted below.

As shown in FIG. 10, the tempered region 140 may be formed in the sidewall portion of the tempered glass substrate 2000. That is, in a method for manufacturing the tempered glass substrate 2000 according to the present invention, a groove may be formed along a boundary portion of a unit cell region of the raw glass substrate 100 (e.g., in the peripheral region), and then, a tempering process may be performed on the resulting structure with the groove, and thus, it is possible to form a tempered region in a sidewall portion of each unit tempered glass substrate and to manufacture the unit tempered glass substrate with an improved sidewall strength property, even when the tempered glass substrate is of the sheet type.

While example embodiments of the present invention have been particularly shown and described with reference to the accompanying drawings, it will be understood by one of ordinary skill in the art that variations in form and detail may be made therein without departing from the spirit and scope of the attached claims. That is, the afore-described embodiments are provided as examples of the present invention, and the present invention should not be construed as being limited to the embodiments set forth herein.

1. A method for manufacturing a touch screen panel, comprising:
smoothing a first surface of a raw glass substrate using a polishing process;
forming a groove, for each cell unit, in the first surface of the raw glass substrate;
tempering the raw glass substrate;
forming a transparent electrode and a wiring pattern on a second surface of the raw glass substrate; and
cutting the raw glass substrate along the groove and for each cell unit,
wherein the second surface is a surface positioned opposite to the first surface.

2. The method of claim 1, wherein the first surface of the raw glass substrate comprises a unit cell region and a peripheral region formed to have a grid shape, and the unit cell region comprises a touch sensing region and an outer region.

3. The method of claim 2, further comprising forming a printed layer on the outer region of the first surface of the raw glass substrate.

4. The method of claim 2, wherein the forming of the groove comprises forming the groove in the peripheral region of the raw glass substrate.

5. The method of claim 4, wherein the forming of the groove is performed in such a way that the peripheral region of the raw glass substrate has a thickness ranging from 10 μm to 100 μm.

6. The method of claim 5, further comprising performing cleaning and drying steps on the raw glass substrate, in which the groove is formed, before the tempering of the raw glass substrate.

7. The method of claim 1, wherein the tempering of the raw glass substrate comprises dipping the raw glass substrate into a potassium-containing source solution at a temperature of 300-450° C. for 4-6 hours.

8. The method of claim 1, wherein the tempering of the raw glass substrate comprises pre-heating the raw glass substrate at a temperature of 350-400° C. for 30-90 minutes and dipping the raw glass substrate into a potassium-containing source solution at a temperature of 300-450° C. for 4-6 hours.

9. The method of claim 7, wherein the potassium-containing source solution contains at least one of potassium nitrate, potassium hydrogenphosphate, potassium chloride, or potassium phosphate.

10. The method of claim 1, wherein the cutting of the raw glass substrate comprises chamfering a cut edge portion of the raw glass substrate and performing cleaning and drying steps.

11. A touch screen panel manufactured by the method according to claim 1.

12. A method for manufacturing a tempered glass substrate, comprising:
smoothing a surface of a raw glass substrate using a polishing process;
forming a groove for each cell unit in the surface of the raw glass substrate;
tempering the raw glass substrate; and
cutting the raw glass substrate along the groove and for each cell unit.

13. The method of claim 12, wherein the surface of the raw glass substrate comprises a unit cell region and a peripheral region formed to have a grid shape, and the forming of the groove comprises forming the groove in the peripheral region of the raw glass substrate.

14. The method of claim 13, wherein the forming of the groove is performed in such a way that the peripheral region of the raw glass substrate has a thickness ranging from 10 μm to 100 μm.

15. The method of claim 14, further comprising performing cleaning and drying steps on the raw glass substrate, in which the groove is formed, before the tempering of the raw glass substrate.

16. The method of claim 12, wherein the tempering of the raw glass substrate comprises dipping the raw glass substrate into a potassium-containing source solution at a temperature of 300-450° C. for 4-6 hours.

17. The method of claim 16, wherein the potassium-containing source solution contains at least one of potassium nitrate, potassium hydrogenphosphate, potassium chloride, or potassium phosphate.

18. The method of claim 12, wherein the cutting of the raw glass substrate comprises chamfering a cut edge portion of the raw glass substrate and performing cleaning and drying steps.
